(19) United States
(12) Patent Application Publication
(10) Pub. No.: US 2012/0074677 A1
(43) Pub. Date: Mar. 29, 2012

(54) AIRBAG, AIRBAG DEVICE, AND METHOD FOR SEWING LID MEMBER OF AIRBAG

(76) Inventors: Teruhiko Hiruta, Tokyo (JP); Mitsuo Maruoka, Tokyo (JP); Makoto Ogawa, Tokyo (JP); Yoshihiro Kobayashi, Tokyo (JP)

(21) Appl. No.: 13/240,726

(22) Filed: Sep. 22, 2011

(30) Foreign Application Priority Data
Sep. 24, 2010 (JP) 2010-214548

(51) Int. Cl. B60R 21/30; B60R 21/16

(52) U.S. Cl. 280/739; 280/743.1

(57) ABSTRACT

Provided are an airbag, an airbag device, and a method for sewing a lid member of an airbag that can make it easier to maintain the internal pressure until inflation and deployment of the airbag are completed and to quickly release gas after an occupant contacts the airbag. An airbag includes a vent hole for releasing gas supplied in the airbag, a lid member for making the vent hole openable and closable, and a tether for applying tension to the lid member. A seam formed by sewing the lid member to the airbag is disposed in a sewing region defined by a straight line shape spaced a predetermined distance from the vent hole, and a curved shape (most curved shape) formed by bringing both ends of the straight line shape close to a center line of the vent hole parallel to the straight line shape. The curvature of the seam can be regulated in view of the lap width between the lid member and the outer edge of the vent hole.

### CROSS-REFERENCE TO RELATED APPLICATION

This application claims priority under 35 U.S.C. §119 to Japanese Patent Application No. JP2010-214548 filed on Sep. 24, 2010, the entire content of which is hereby incorporated herein by reference in its entirety.

### FIELD OF THE INVENTION

The present invention relates to an airbag and an airbag device installed in a vehicle such as an automobile, and a method for sewing a lid member of an airbag. More specifically, the present invention relates to an airbag and an airbag device and a method for sewing a lid member of an airbag characterized by an opening and closing of a vent hole.

### BACKGROUND OF THE INVENTION

A vehicle such as an automobile is generally equipped with airbag devices for inflating and deploying airbags in the vehicle to absorb the impact on occupants upon collision or sudden deceleration. Various types of airbag devices have been developed and are used, for example, a driver-side airbag device mounted in a steering wheel, a passenger-side airbag device mounted in an instrument panel, a side airbag device mounted in the side of a vehicle or in a seat, a curtain airbag device mounted in the upper portions of doors, and a knee airbag device for the knees of an occupant.

These airbag devices generally have an airbag and an inflator. The airbag is normally folded and is inflated and deployed in an emergency, and the inflator supplies gas to the airbag. The airbag often has a vent hole through which gas in the airbag is released. When an occupant or the like contacts the inflated airbag, the vent hole releases gas in the airbag to absorb shock to the occupant or the like.

If the vent hole is normally open, gas leaks during inflation and deployment of the airbag, which is inefficient. It has already been proposed to provide an airbag with a lid member for making a vent hole openable and closable (see, for example, Japanese Unexamined Patent Application Publication Nos. 2010-36770 and 2008-189143).

Japanese Unexamined Patent Application Publication Nos. 2010-36770 and 2008-189143 describe airbags in which an openable and closable vent hole is closed by a lid member (gas discharge preventive member) until an occupant contacts an occupant-facing surface of the inflated airbag, and the vent hole is opened when an occupant contacts the occupant-facing surface of the inflated airbag and the occupant-facing surface is pushed backward.

The airbag described in Japanese Unexamined Patent Application Publication No. 2010-36770 has a connecting member for connecting a lid member and a head-facing portion. When the airbag is inflated and an occupant is out of contact with the head-facing portion, the connecting member is tight between the head-facing portion and the lid member, tension is thereby applied to the lid member, and the vent hole is closed or slightly opened. When an occupant contacts the head-facing portion of the inflated airbag, and the head-facing portion is thereby pushed backward, the connecting member slacks, the tension is thereby reduced, and the vent hole is opened or wide opened.

The airbag described in Japanese Unexamined Patent Application Publication No. 2008-189143 includes a front panel forming an occupant-facing surface, a rear panel forming an outer surface opposite to the occupant-facing surface, a pair of strings for connecting the front panel and the rear panel in the airbag, a vent hole for allowing the inside and the outside of the airbag to communicate with each other, a lid member for covering the vent hole from an outer side of the airbag and preventing the discharge of gas through the vent hole, and a tether as a connecting member for connecting the lid member to the strings through the vent hole.

The lid members described in Japanese Unexamined Patent Application Publication Nos. 2010-36770 and 2008-189143 are each a substantially sectorial base cloth sewn to form an arc-like seam, and are each connected to a tether (connecting member) through a tether opening or a normally open vent hole formed in the airbag.

### SUMMARY OF THE INVENTION

The above-described openable and closable vent holes are required to have two functions: maintenance of the internal pressure until inflation and deployment of the airbag are completed; and quick deflation after an occupant contacts the airbag. However, in the airbag described in Japanese Unexamined Patent Application Publication No. 2010-36770, because the tether opening is left open, there is a tendency of gas to leak upon inflation and deployment of the airbag. In addition, because an opening and closing of the lid member is controlled only by the tension of the tether (connecting member), it is difficult to control the opening and closing of the lid member according to schedule.

The present invention is made in view of the above problems. An object of the present invention is to provide an airbag, an airbag device, and a method for sewing a lid member of an airbag that can make it easier to maintain the internal pressure until inflation and deployment of the airbag are completed and to quickly release gas after an occupant contacts the airbag.

The present invention provides an airbag including a vent hole for releasing gas supplied in the airbag, a lid member for making the vent hole openable and closable, and a tether for applying tension to the lid member. A seam formed by sewing the lid member to the airbag is disposed in a sewing region defined by a straight line shape spaced a predetermined distance from the vent hole, and a curved shape formed by bringing both ends of the straight line shape close to a center line of the vent hole parallel to the straight line shape. A curvature of the seam can be regulated in view of lap width between the lid member and an outer edge of the vent hole.

The present invention provides an airbag device including an airbag an inflator. The airbag is normally folded and is inflated and deployed in an emergency, and the inflator supplies gas to the airbag. The airbag includes a vent hole for releasing gas supplied in the airbag, a lid member for making the vent hole openable and closable, and a tether for applying tension to the lid member. A seam formed by sewing the lid member to the airbag is disposed in a sewing region defined by a straight line shape spaced a predetermined distance from the vent hole, and a curved shape formed by bringing both ends of the straight line shape close to a center line of the vent hole parallel to the straight line shape. A curvature of the seam can be regulated in view of lap width between the lid member and an outer edge of the vent hole.

In the above-described airbag and airbag device according to the present invention, the lid member may be disposed on an outer surface of the airbag, the airbag may have a tether opening through which the tether is inserted, and the tether opening may be formed in a portion covered by the lid member.

The tether may have a connecting portion sewn to the lid member, the connecting portion may be wider than a tether main body portion inserted through the tether opening, the connecting portion may have cuts formed along the tether main body portion, and protruding portions formed by the cuts may cover the tether opening.

A cover member having an opening may be disposed over the lid member such that the lid member can be ejected through the vent hole or the opening. In this case, the tether may be omitted.

The lid member may be disposed on the outer surface of the airbag, and the cover member may be disposed on an outer side of the lid member; or the lid member may be disposed on an inner surface of the airbag, and the cover member may be disposed on an inner side of the lid member.

The opening may have an opening area larger than the vent hole.

The present invention provides a method for sewing a lid member of an airbag. The airbag includes a vent hole for releasing gas supplied in the airbag, the lid member for making the vent hole openable and closable, and a tether for applying tension to the lid member. The method includes the steps of disposing a seam formed by sewing the lid member to the airbag in a sewing region defined by a straight line shape spaced a predetermined distance from the vent hole, and a curved shape formed by bringing both ends of the straight line shape close to a center line of the vent hole parallel to the straight line shape, and regulating a curvature of the seam in view of lap width between the lid member and an outer edge of the vent hole so that an opening and closing of the vent hole can be regulated.

The method may further include the steps of disposing a cover member having an opening over the lid member, and putting the lid member between the airbag and the cover member so that the opening and closing of the vent hole can be regulated by changing size of the opening. In this case, the tether does not necessarily need to be connected to the airbag.

According to the above-described airbag, airbag device, and method for sewing a lid member of an airbag according to the present invention, a shape (curvature) of the seam of the lid member can be regulated in view of lap width between the lid member and the airbag. Thus, a shape of the seam suitable for the size of the lid member can be set, and the timing for the lid member to open and close can be regulated. Therefore, the internal pressure can be easily maintained until inflation and deployment of the airbag are completed, and quick deflation after the contact of an occupant with the airbag can be easily performed.

When a tether opening is formed at a location where the tether opening can be covered by the lid member, the tether opening can be covered by the lid member, and the gas leak upon inflation and deployment of the airbag can be reduced.

When protruding portions capable of covering the tether opening are formed in the connecting portion of the tether, the gas leak upon inflation and deployment of the airbag can be further reduced.

When the lid member is put between a cover member and the airbag, the lid member can be easily brought into close contact with the airbag, and the vent hole can be prevented from being opened by disturbance before a predetermined pressure is reached.

When a cover member is disposed, the lid member can be disposed either on the outer side or on an inner side of the airbag, and the possibility of design can be expanded.

When the opening of the cover member is larger than the vent hole, the shape of the part of the lid member covering the vent hole can be maintained constant, the condition of the pressure applied to the lid member through the vent hole can be made constant, and the opening and closing of the vent hole can be controlled easily.

When a cover member is disposed, the opening and closing of the lid member can be regulated using the frictional force between the cover member and the lid member, the tether can be omitted, and the structure of the airbag can be simplified.

### BRIEF DESCRIPTION OF THE DRAWINGS

FIG. 1 shows sectional views of an airbag device according to a first embodiment of the present invention, wherein FIG. 1A shows a state where inflation and deployment are completed, and FIG. 1B shows a state where a vent hole is open.

FIG. 2 shows the airbag according to the first embodiment of the present invention, wherein FIG. 2A is an enlarged view of a lid member, FIG. 2B is a sectional view taken along line B-B of FIG. 2A, and FIG. 2C shows a modification of a tether.

FIG. 3 shows modifications of the lid member shown in FIG. 1, wherein FIG. 3A shows a first modification, FIG. 3B shows a second modification, FIG. 3C shows a third modification, and FIG. 3D shows a fourth modification.

FIG. 4 shows the working of the lid members shown in FIG. 3, wherein FIG. 4A is a schematic diagram showing the deformation of the lid members when the vent hole is open, and FIG. 4B shows the relationship between X displacement and Z displacement of the lid members.

FIG. 5 shows sectional views of an airbag device according to a second embodiment of the present invention, wherein FIG. 5A shows a state where inflation and deployment are completed, and FIG. 5B shows a state where a vent hole is open.

FIG. 6 shows the airbag according to the second embodiment of the present invention, wherein FIG. 6A is an enlarged view of a lid member, FIG. 6B is a sectional view taken along line B-B of FIG. 6A, and FIG. 6C shows a modification.

FIG. 7 shows sectional views of an airbag device according to a third embodiment of the present invention, wherein FIG. 7A shows a state where inflation and deployment are completed, and FIG. 7B shows a state where a vent hole is open.

FIG. 8 shows the airbag according to the third embodiment of the present invention, wherein FIG. 8A is an enlarged view of a lid member, FIG. 8B is a sectional view taken along line B-B of FIG. 8A, and FIG. 8C shows a modification.

FIG. 9 shows examples of arrangement of the lid member, wherein FIG. 9A shows a first arrangement example, FIG. 9B shows a second arrangement example, FIG. 9C shows a third arrangement example, and FIG. 9D shows a fourth arrangement example.

FIG. 10 shows sectional views of airbag devices according to other embodiments of the present invention, wherein FIG. 10A shows a fourth embodiment, FIG. 10B shows a fifth embodiment, and FIG. 10C shows a sixth embodiment.

### DETAILED DESCRIPTION OF THE PREFERRED EMBODIMENTS

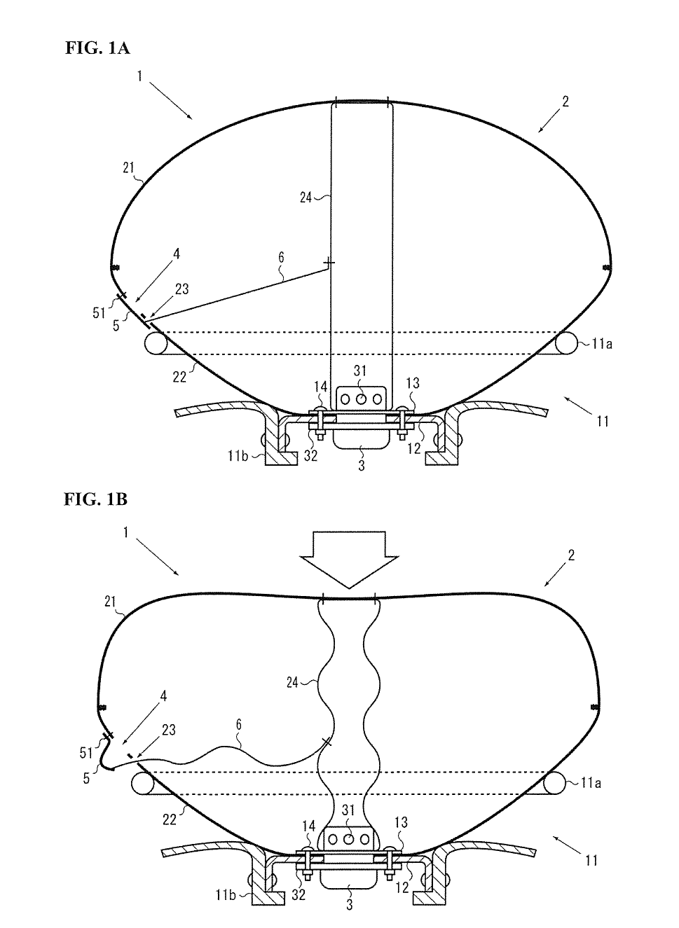

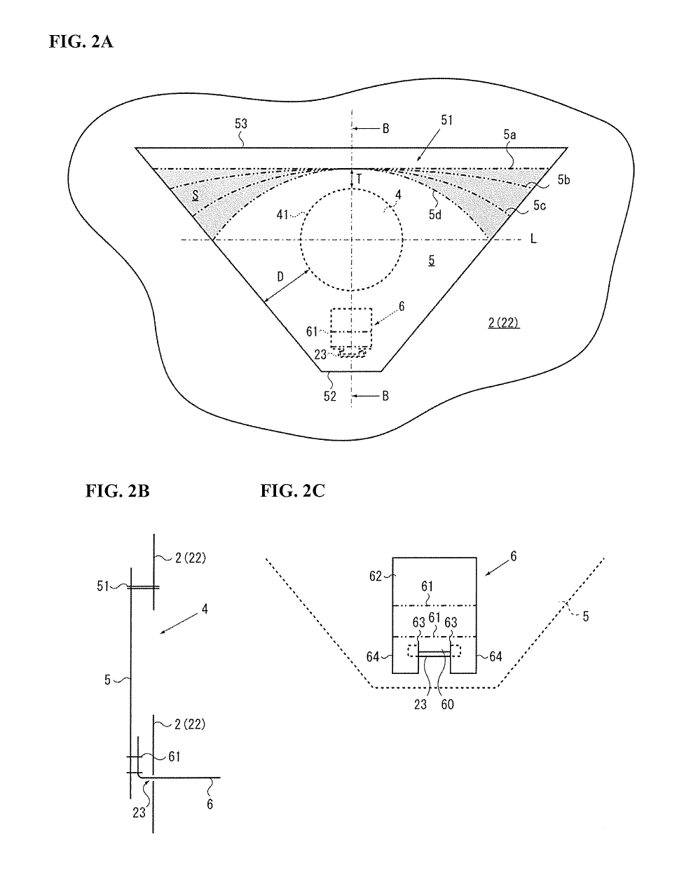

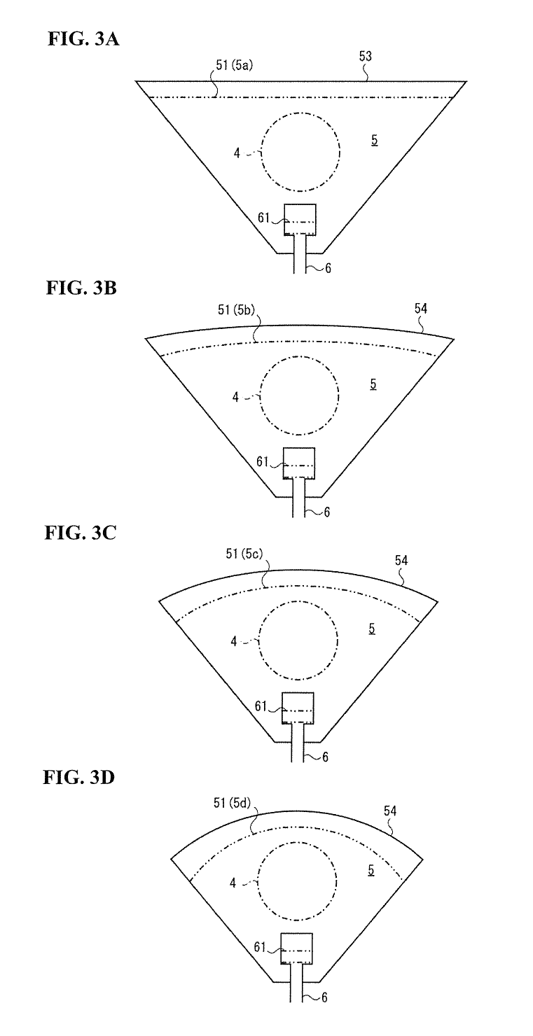

The embodiments of the present invention will now be described with reference to FIGS. 1 to 10. FIG. 1 shows sectional views of an airbag device according to a first embodiment of the present invention, wherein FIG. 1A shows a state where inflation and deployment are completed, and FIG. 1B shows a state where a vent hole is open. FIG. 2 shows the airbag according to the first embodiment of the present invention, wherein FIG. 2A is an enlarged view of a lid member, FIG. 2B is a sectional view taken along line B-B of FIG. 2A, and FIG. 2C shows a modification of a tether. FIG. 3 shows modifications of the lid member shown in FIG. 1, wherein FIG. 3A shows a first modification, FIG. 3B shows a second modification, FIG. 3C shows a third modification, and FIG. 3D shows a fourth modification.

As shown in FIGS. 1 to 3, an airbag device 1 according to a first embodiment of the present invention has an airbag 2 and inflator 3. The airbag 2 is normally folded and is inflated and deployed in an emergency, and the inflator 3 supplies gas to the airbag 2. The airbag 2 includes a vent hole 4 for releasing gas supplied in the airbag, a lid member 5 for making the vent hole 4 openable and closable, and a tether 6 for applying tension to the lid member 5. A seam 51 formed by sewing the lid member 5 to the airbag 2 is disposed in a sewing region S defined by a straight line shape 5a spaced a predetermined distance from the vent hole 4, and a curved shape (most curved shape 5d) formed by bringing both ends of the straight line shape 5a close to a center line L of the vent hole 4 parallel to the straight line shape 5a. A curvature of the seam 51 can be regulated in view of lap width D between the lid member 5 and an outer edge 41 of the vent hole 4.

The airbag device 1 shown in FIG. 1 is a driver-side airbag device. The airbag device 1 is generally disposed in a steering wheel 11 with which an occupant controls the rudder angle. The steering wheel 11 includes an annular rim portion 11a, a boss portion (not shown) forming a joint for connecting with a steering shaft (not shown), and a plurality of spoke portions (not shown) connecting the rim portion 11a and the boss portion. On the occupant side of the boss portion, an airbag cover 11b is disposed. In the airbag cover 11b, the airbag device 1 is housed. The airbag cover 11b generally has a thin portion (tear line) that cleaves upon inflation and deployment of the airbag 2. As shown in FIG. 1, the airbag cover 11b is cleaved by being pressed by the inflating airbag 2, and ejects the airbag 2 to the interior of the vehicle.

The inflator 3 is, for example, a substantially cylindrical gas generator. At the tip of the inflator 3, gas jetting ports 31 are formed. In the middle of the inflator 3, a flange portion 32 for securing the inflator is formed. The inflator 3 is secured to a retainer 12 secured to the airbag cover 11b. Specifically, the inflator 3 is secured to the retainer 12 by inserting the tip portion of the inflator 3 into the opening of the retainer 12, passing the tip portion of the inflator 3 through the opening of the airbag 2, passing the tip portion of the inflator 3 through a holding ring 13, passing bolts 14 through the flange portion 32 of the inflator 3, the retainer 12, the airbag 2, and the holding ring 13, and then tightening nuts. The above structure for securing the inflator 3 is just one example, and various existing securing structures can be applied.

The airbag 2 includes a front panel 21 disposed on the occupant side, and a rear panel 22 disposed on the steering wheel 11 side, and is formed into a bag body by sewing the circumferences of these panels. In the airbag 2, a shape restricting member 24 may be disposed that is a strip-shaped or substantially cylindrical base cloth connecting the top portion and the bottom portion of the airbag 2. A shape restricting member having the same configuration as the conventional art described, for example, in Japanese Unexamined Patent Application Publication No. 2008-189143 can be used as the shape restricting member 24. The shape restricting member 24 may be a partition member that divides the airbag 2 into a plurality of inflating chambers. The shape of the airbag 2 and the method for forming a bag body are not limited to those shown in the figures. Various shapes, such as a twin bag, and various forming methods can be applied.

The vent hole 4 is formed, for example, on the rear panel 22 side of the airbag 2. Here, the vent hole 4 is formed on an inner side of the rim portion 11a of the steering wheel 11 (between the rim portion 11a and the inflator 3). The vent hole 4 is often formed in a circular shape as shown in FIG. 2. However, the vent hole 4 may be formed in an elliptical shape or a rectangular shape. The size (opening area) of the vent hole 4 is set according to conditions such as the type, shape, and capacity of the airbag 2, the capacity of the inflator 3, and the location where the vent hole 4 is formed.

The lid member 5 is a member that is sewn to the airbag 2 and opens and closes the vent hole 4. As shown in FIG. 1A, the lid member 5 is disposed on an outer surface of the airbag 2 (rear panel 22) and on an outer side of the rim portion 11a of the steering wheel 11, and the end of the lid member 5 on the front panel 21 side is sewn to the airbag 2 (rear panel 22) and forms a seam 51. On the side opposite to the seam 51 (on the rim portion 11a side), a tether 6 is sewn.

One end of the tether 6 is connected to the shape restricting member 24, and the other end is connected to the back surface of the lid member 5 through the airbag 2 (rear panel 22). In the case where the tether 6 is sewn to the shape restricting member 24, the length of the tether 6 can be reduced, and the cost, weight, and size in the folded state can be reduced. As shown in FIG. 2B, the tether 6 is inserted through a tether opening 23 formed in the rear panel 22 and penetrates the airbag 2. The tether opening 23 is, for example, as shown in FIG. 2A, formed in a slit shape and at a location covered by the lid member 5. That is, the lid member 5 is disposed on an outer side of the airbag 2, the airbag 2 has a tether opening 23 through which the tether 6 is inserted, and the tether opening 23 is formed in a portion covered by the lid member 5. The tether 6 is, for example, a band-like base cloth. However, the tether 6 may be a string-like strap.

The seam 61 formed by sewing the tether 6 to the lid member 5 is wider than the tether 6. The tether 6 disposed in the airbag 2 is preferably narrow so as not to interfere with gas flow. However, because the tether 6 is subjected to a certain tension, the tether 6 needs to be sewn to the lid member 5 with a certain binding force. Thus, the end portion of the tether 6 forming the seam 61 is wider. The tether 6 has a function to apply tension to the lid member 5 and a function to restrict the shape (the airbag inflation width in the occupant direction) of the airbag 2. The position to which the tether 6 is connected is not limited to that shown in the figures. The tether 6 may be connected to an inner surface of the top portion of the airbag 2, another tether disposed in the airbag 2, or the like.

The modification of the tether 6 shown in FIG. 2C may be used. In this modification of the tether 6, the shape of the seam 61 formed by sewing the tether 6 to the lid member 5 is modified. Specifically, the tether 6 has a connecting portion 62 sewn to the lid member 5. The connecting portion 62 is wider than the tether main body portion 60 inserted through the tether opening 23. The connecting portion 62 has cuts 63 formed along the tether main body portion 60. Protruding portions 64 formed by the cuts 63 cover the tether opening 23. Owing to such a configuration, when the tether main body portion 60 is inserted through the tether opening 23, the unstopped parts of the tether opening 23 can be stopped by the protruding portions 64, and the gas leak upon inflation and deployment of the airbag 2 can be further reduced.

With reference to FIG. 2, a method for sewing the lid member 5 will be described. As shown in FIG. 2A, the lid member 5 has, for example, a trapezoidal shape having a short side portion 52 and a long side portion 53. The tether 6 is sewn to the short side portion 52, and the long side portion 53 is sewn to the airbag 2. The lid member 5 may have a triangular shape having a long side portion 53.

The seam 51 of the lid member 5 is formed in a sewing region S shown by shading in FIG. 2A. The sewing region S is a region surrounded by a straight line shape 5a spaced a distance T from the top of the vent hole 4 and parallel to the long side portion 53, and a most curved shape 5d formed by bringing both ends of the straight line shape 5a close to a center line L of the vent hole 4 parallel to the straight line shape 5a along the oblique sides of the lid member 5. The distance T is set according to conditions such as the location where the vent hole 4 is disposed, the size of the vent hole 4, the amount of gas to be released, the timing to release gas, and the pressure at which gas is released. A shape (curvature) of the seam 51 in the sewing region S is regulated in view of conditions such as the lap width D between the lid member 5 and the outer edge 41 of the vent hole 4, the amount of gas to be released through the vent hole 4, the timing to release gas, and the pressure at which gas is released. The lap width D means the shortest distance between the outer peripheral portion of the lid member 5 and the outer edge 41 of the vent hole 4.

The seam 51 is formed, for example, as shown in FIG. 2A, in any one of a straight line shape 5a, a first curved shape 5b, a second curved shape 5c, and a most curved shape 5d. In this case, as shown in FIGS. 3A to 3D, the shape of the lid member 5 may be formed according to the shape of the seam 51. FIGS. 3A to 3D each show a lid member 5 as viewed from the back surface to which the tether 6 is connected. The location of the vent hole 4 is shown by a long dashed short dashed line.

In the first modification of the lid member 5 shown in FIG. 3A, the seam 51 is set in the straight line shape 5a. In this case, the lid member 5 is formed in a trapezoidal shape.

In the second modification of the lid member 5 shown in FIG. 3B, the seam 51 is set in the first curved shape 5b. In this case, the lid member 5 is formed in a substantially sectorial shape having an arc portion 54. A curvature of the arc portion 54 is set such that the arc portion 54 curves along the first curved shape 5b.

In the third modification of the lid member 5 shown in FIG. 3C, the seam 51 is set in the second curved shape 5c. Also in this case, the lid member 5 is formed in a substantially sectorial shape having an arc portion 54. The curvature of the arc portion 54 is set such that the arc portion 54 curves along the second curved shape 5c. Therefore, the curvature of the arc portion 54 of the third modification is set so as to be larger than the curvature of the arc portion 54 of the second modification.

In the fourth modification of the lid member 5 shown in FIG. 3D, the seam 51 is set in the most curved shape 5d. Also in this case, the lid member 5 is formed in a substantially sectorial shape having an arc portion 54. The curvature of the arc portion 54 is set such that the arc portion 54 curves along the most curved shape 5d. Therefore, the curvature of the arc portion 54 of the fourth modification is set to a maximum value larger than the curvature of the arc portion 54 of the third modification.

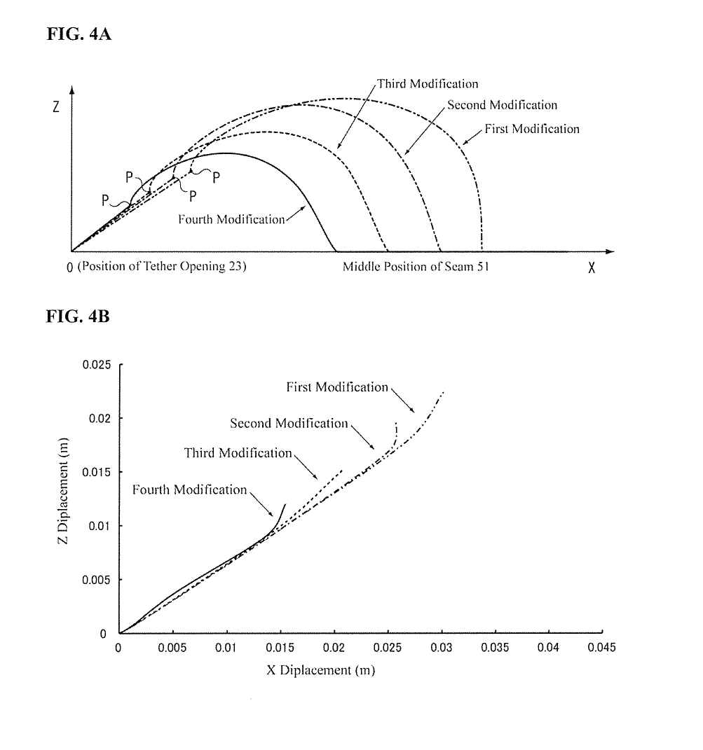

FIG. 4 shows the working of the lid members shown in FIG. 3, wherein FIG. 4A is a schematic diagram showing the deformation of the lid members when the vent hole is open, and FIG. 4B shows the relationship between X displacement and Z displacement of the lid members. In each graph, the long dashed double-short dashed line shows the first modification shown in FIG. 3A, the long dashed short dashed line shows the second modification shown in FIG. 3B, the dashed line shows the third modification shown in FIG. 3C, and the solid line shows the fourth modification shown in FIG. 3D. In FIG. 4A, the X axis shows the direction of the center line of the lid member 5 on the surface of the airbag 2, the Z axis shows the direction of the height of the lid member 5 from the surface of the airbag 2, the origin shows the position of the tether opening 23, and the point of contact with the X axis in each modification shows the middle position of the seam 51. FIG. 4B shows the loci (X displacement and Z displacement) of measure points P in FIG. 4A. The measure points P are set at the position of the short side portion 52 of the lid member 5 in each modification.

As shown in FIG. 4A, the curling position of the lid member 5 in the X direction is largest in the first modification followed by the second modification, the third modification, and the fourth modification in that order. The curling height of the lid member 5 in the Z direction is also largest in the first modification followed by the second modification, the third modification, and the fourth modification in that order. That is, the distance from the surface of the airbag is largest in the first modification followed by the second modification, the third modification, and the fourth modification in that order. This is clear from the loci of measure points P in FIG. 4B. The X displacement (m) and Z displacement (m) are largest in the first modification followed by the second modification, the third modification, and the fourth modification in that order.

As described above, by regulating the curvature of the seam 51, the degree of curling (the amount of opening) of the lid member 5 can be regulated. When the amount of opening of the lid member 5 is large, the degree of opening of the vent hole 4 can be increased, and gas can be released quickly. On the other hand, when the amount of opening of the lid member 5 is small, the degree of opening of the vent hole 4 can be reduced, and the amount of released gas can be reduced to effectively maintain the internal pressure.

Therefore, by using the method for sewing a lid member 5 of an airbag 2 according to the present invention, that is, a method for sewing a lid member 5 of an airbag 2, the airbag including a vent hole 4 for releasing gas supplied in the airbag, the lid member 5 for making the vent hole 4 openable and closable, and a tether 6 for applying tension to the lid member 5, the method including the steps of disposing a seam 51 formed by sewing the lid member 5 to the airbag 2 in a sewing region S defined by a straight line shape 5a spaced a predetermined distance T from the vent hole 4, and a curved shape (most curved shape 5d) formed by bringing both ends of the straight line shape 5a close to a center line L of the vent hole 4 parallel to the straight line shape 5a, and regulating the curvature of the seam 51 in view of the lap width D between the lid member 5 and the outer edge 41 of the vent hole 4 so that an opening and closing of the vent hole 4 can be regulated, two functions: maintenance of the internal pressure until inflation and deployment of the airbag 2 are completed; and quick deflation after an occupant contacts the airbag 2 can be regulated according to the shape and characteristics of the airbag 2, and a highly functional airbag 2 can be easily provided.

Next, the working of the above-described airbag device 1 will be described with reference to FIG. 1. Although not shown, the airbag 2 is normally folded and housed in an uncleaved airbag cover 11b. When an in-vehicle sensor predicts or detects an emergency such as a collision or sudden deceleration of the vehicle, an ignition command is transmitted from the electronic control unit (ECU) to the inflator 3, and gas is jetted from the inflator 3 into the airbag 2. The airbag 2 is inflated by gas being supplied thereto, presses and cleaves the airbag cover 11b, is ejected to the interior of the vehicle, and is inflated and deployed.

As shown in FIG. 1A, when the airbag 2 has completed inflation and deployment, the tether 6 is tight and presses the lid member 5 against the surface of the airbag 2 so as to close the vent hole 4. At this time, because the tether opening 23 is formed behind the lid member 5, the tether opening 23 can be covered by the lid member 5, and the gas leak upon inflation and deployment of the airbag 2 can be reduced.

As shown in FIG. 1B, for example, when an occupant contacts the airbag 2, the internal pressure of the airbag 2 increases, a certain pressure is applied to the lid member 5, and the tether 6 slacks as the shape restricting member 24 slacks. As a result, the lid member 5 goes out of contact with the surface of the airbag 2 and opens the vent hole 4. When the vent hole 4 is opened, gas in the airbag 2 is released, the internal pressure of the airbag 2 decreases, and the shock to the occupant colliding with the airbag 2 can be cushioned.

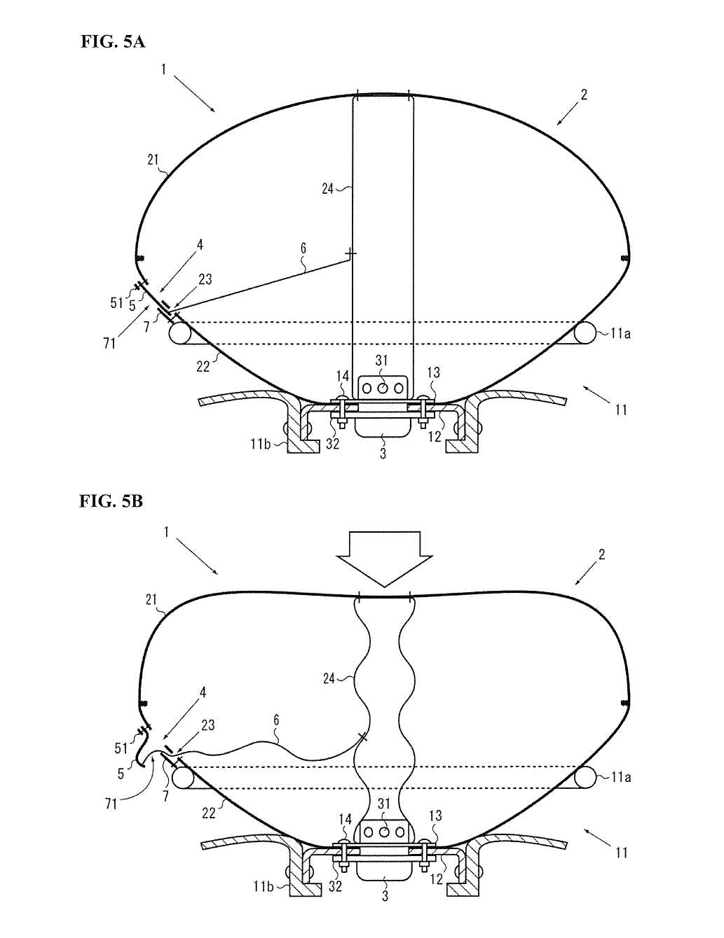

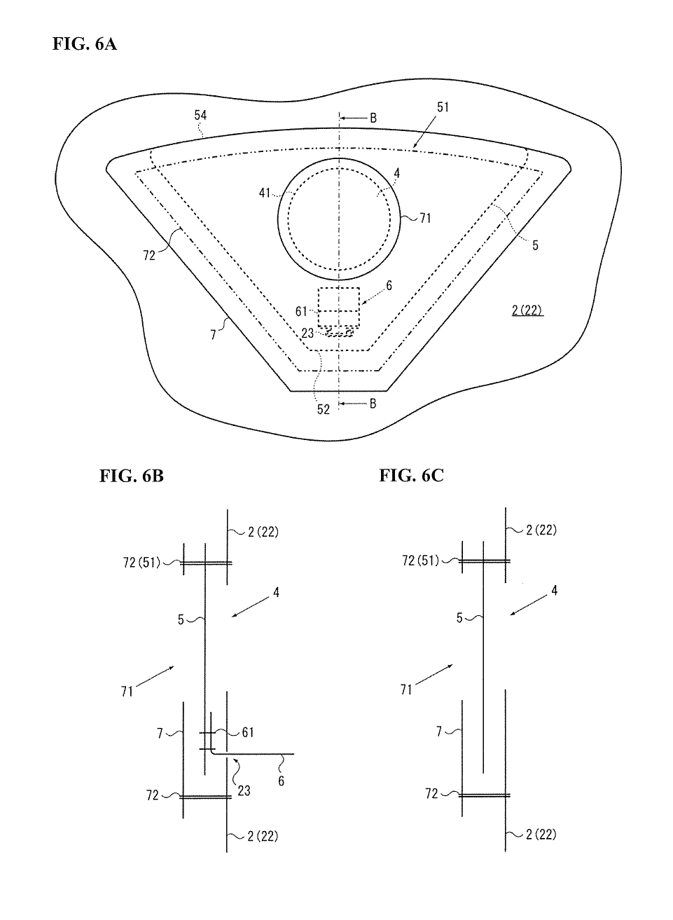

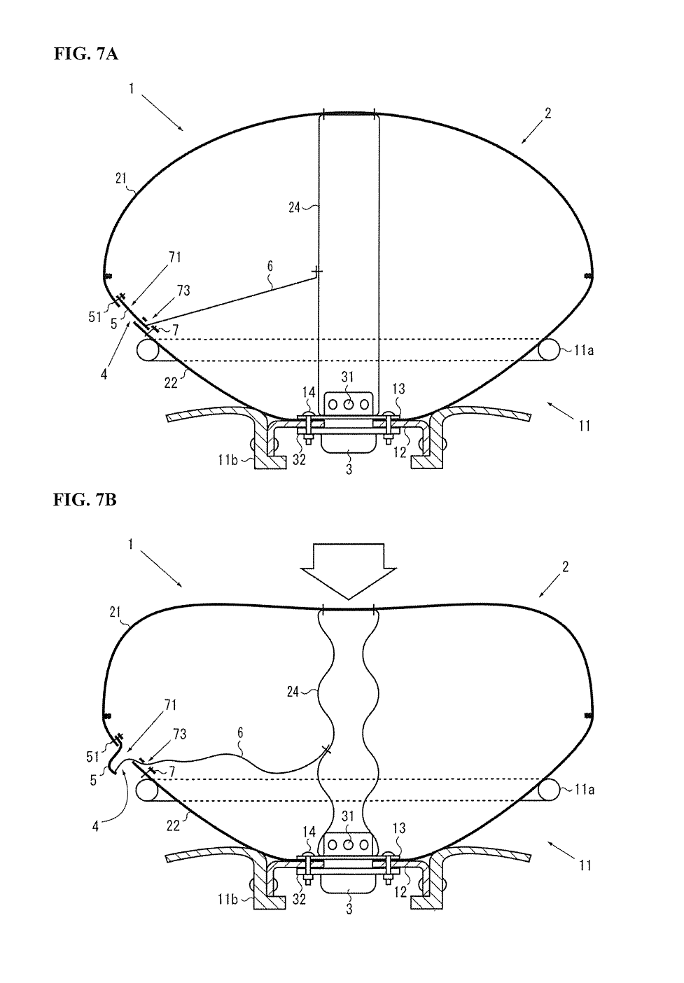

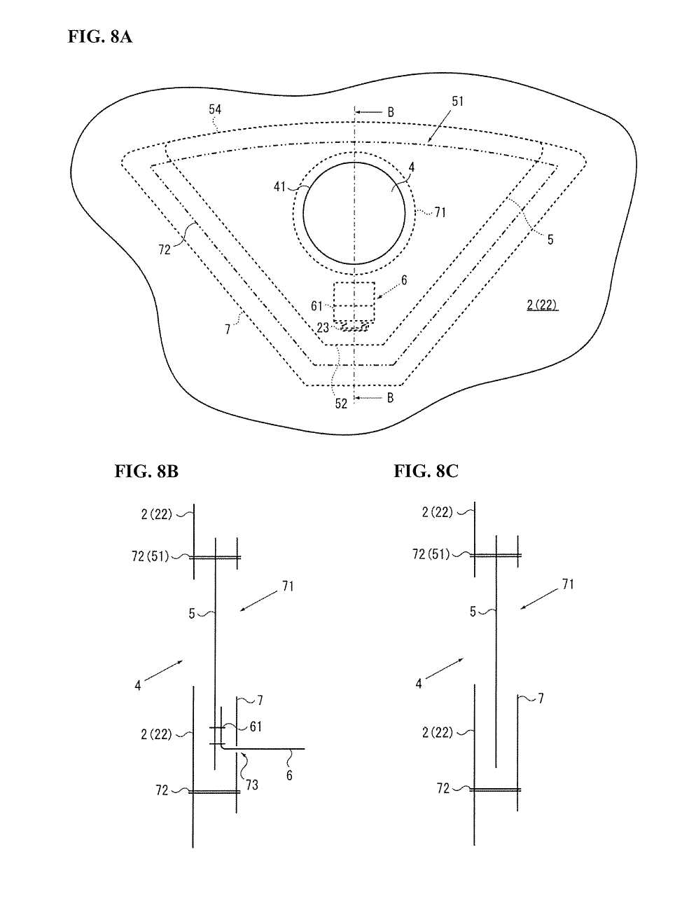

Next, airbag devices 1 and airbags 2 according to other embodiments of the present invention will be described. FIG. 5 shows sectional views of an airbag device according to a second embodiment of the present invention, wherein FIG. 5A shows a state where inflation and deployment are completed, and FIG. 5B shows a state where a vent hole is open. FIG. 6 shows the airbag according to the second embodiment of the present invention, wherein FIG. 6A is an enlarged view of a lid member, FIG. 6B is a sectional view taken along line B-B of FIG. 6A, and FIG. 6C shows a modification. FIG. 7 shows sectional views of an airbag device according to a third embodiment of the present invention, wherein FIG. 7A shows a state where inflation and deployment are completed, and FIG. 7B shows a state where a vent hole is open. FIG. 8 shows the airbag according to the third embodiment of the present invention, wherein FIG. 8A is an enlarged view of a lid member, FIG. 8B is a sectional view taken along line B-B of FIG. 8A, and FIG. 8C shows a modification. The same reference numerals will be used to designate the same components as those of the airbag device 1 and airbag 2 according to the first embodiment shown in FIGS. 1 and 2, and the redundant description thereof will be omitted.

In the second embodiment shown in FIGS. 5 and 6, a cover member 7 having an opening 71 is disposed over a lid member 5 such that the lid member 5 can be ejected through the opening 71. Specifically, the lid member 5 is disposed on the outer surface of the airbag 2 (for example, the rear panel 22), and the cover member 7 is disposed on an outer side of the lid member 5. That is, in the second embodiment, a cover member 7 is disposed on the outer side of the lid member 5 shown in the first rotation.

As shown in FIG. 6A, the cover member 7 is similar to the lid member 5 in shape but larger in size, and is sewn to the airbag 2 by a seam 72 shown by a long dashed double-short dashed line. Therefore, the cover member 7 and the airbag 2 form a bag portion having a vent hole 4 and an opening 71, and the lid member 5 is located in the bag portion. The seam 51 along the arc portion 54 of the lid member 5 may be used also as the seam 72 of the cover member 7, or may be formed separately therefrom. The opening 71 may have an opening area larger than the vent hole 4. When the opening 71 is larger than the vent hole 4, the shape of the part of the lid member 5 covering the vent hole 4 can be maintained constant, the condition of the pressure applied to the lid member 5 through the vent hole 4 can be made constant, and the opening and closing of the vent hole 4 can be controlled easily. The opening 71 and the vent hole 4 may be disposed concentrically, or may be disposed eccentrically. The shape of the opening 71 is not limited to a circular shape. The opening 71 can be formed in various shapes such as an elliptical shape and a rectangular shape.

As shown in FIG. 6B, the lid member 5 is located in the gap between the airbag 2 and the cover member 7, and is secured in the gap by the seam 51 (72). Therefore, the end of the lid member 5 to which the tether 6 is connected can be moved or restrained depending on the relationship among the pressure applied to the lid member 5, the tension applied to the tether 6, and the frictional force generated between the cover member 7 and the airbag 2. For example, when the pressure applied to the lid member 5 through the vent hole 4 is larger than the sum of the tension applied to the tether 6 and the frictional force generated between the cover member 7 and the airbag 2, the lid member 5 is ejected to the outside through the opening 71 and opens the vent hole 4. By regulating the size and shape of the opening 71, the frictional force acting on the lid member 5 can be regulated.

As described above, when the lid member 5 is put between the cover member 7 and the airbag 2, the lid member 5 can be easily brought into close contact with the airbag 2, the vent hole 4 can be prevented from being opened by disturbance before a predetermined pressure is reached, and the internal pressure maintenance ability can be improved.

As shown in FIG. 6C, the tether 6 may be omitted (the tether 6 does not necessarily need to be connected to the airbag 2). When sufficient frictional force acts on the lid member 5 owing to the cover member 7, the lid member 5 can open and close the vent hole 4 even if the tension of the tether 6 is omitted. By omitting the tether 6, the structure of the airbag 2 can be simplified.

Next, the working of the above-described airbag device 1 according to the second embodiment will be described with reference to FIG. 5. The operation before inflation and deployment of the airbag 2 are completed is the same as in the first embodiment, and therefore the detailed description thereof will be omitted.

As shown in FIG. 5A, when the airbag 2 has completed inflation and deployment, the tether 6 is tight and presses the lid member 5 against the surface of the airbag 2 so as to close the vent hole 4. At this time, the lid member 5 is located between the cover member 7 and the airbag 2. Because the tether opening 23 formed in the airbag 2 is formed behind the lid member 5, the tether opening 23 can be covered by the lid member 5, and the gas leak upon inflation and deployment of the airbag 2 can be reduced.

As shown in FIG. 5B, for example, when an occupant contacts the airbag 2, the internal pressure of the airbag 2 increases, a certain pressure is applied to the lid member 5, and the tether 6 slacks as the shape restricting member 24 slacks. As a result, the lid member 5 is released from restriction by the tether 6, and the end of the lid member 5 becomes movable. With the increase in the internal pressure of the airbag 2, the pressure applied to the lid member 5 through the vent hole 4 increases. The end and outer periphery of the lid member 5 (the parts other than the seam 51) move in the gap between the cover member 7 and the airbag 2 against the frictional force gradually toward the opening 71. The lid member 5 is gradually ejected through the opening 71 to the outside. Finally, when a part of the lid member 5 is ejected through the opening 71 to the outside, gas in the airbag 2 is released through the vent hole 4 and the opening 71 to the outside.

In the third embodiment shown in FIGS. 7 and 8, a cover member 7 having an opening 71 is disposed over a lid member 5 such that the lid member 5 can be ejected through the vent hole 4. Specifically, the lid member 5 is disposed on the inner surface of the airbag 2 (for example, the rear panel 22), and the cover member 7 is disposed on an inner side of the lid member 5. That is, in the third embodiment, the lid member 5 and the cover member 7 shown in the second embodiment are disposed on an inner side of the airbag 2.

As shown in FIGS. 8A and 8B, the configuration of the cover member 7 is basically the same as the second embodiment. Because the cover member 7 is disposed on the inner side of the airbag 2 and the lid member 5, a tether opening 73 is formed in the cover member 7. The tether opening 73 may be formed in a slit shape in a part of the cover member 7, or may be formed by forming a gap in a part on the short side portion 52 side of the seam 72. As shown in FIG. 8C, the tether 6 may be omitted (the tether 6 does not necessarily need to be connected to the airbag 2).

As described above, when the cover member 7 is disposed, the lid member 5 can be disposed on the inner side of the airbag 2, and the possibility of design can be expanded.

Next, the working of the above-described airbag device 1 according to the third embodiment will be described with reference to FIG. 7. The operation before inflation and deployment of the airbag 2 are completed is the same as in the first embodiment, and therefore the detailed description thereof will be omitted.

As shown in FIG. 7A, when the airbag 2 has completed inflation and deployment, the tether 6 is tight and presses the lid member 5 against the cover member 7. At this time, the internal pressure of the airbag 2 is applied to the vent hole 4 through the opening 71. Therefore, the lid member 5 remains located in the gap between the cover member 7 and the airbag 2, and is closing the vent hole 4. Because the tether opening 73 is not formed in the airbag 2, and the gas leak upon inflation and deployment of the airbag 2 can be reduced.

As shown in FIG. 7B, for example, when an occupant contacts the airbag 2, the internal pressure of the airbag 2 increases, a certain pressure is applied to the lid member 5, and the tether 6 slacks as the shape restricting member 24 slacks. As a result, the lid member 5 is released from restriction by the tether 6, and the end of the lid member 5 becomes movable. With the increase in the internal pressure of the airbag 2, the pressure applied to the lid member 5 through the opening 71 increases. The end and outer periphery of the lid member 5 (the parts other than the seam 51) move in the gap between the cover member 7 and the airbag 2 against the frictional force gradually toward the vent hole 4. The lid member 5 is gradually ejected through the vent hole 4 to the outside. Finally, when a part of the lid member 5 is ejected through the vent hole 4 to the outside, gas in the airbag 2 is released through the opening 71 and the vent hole 4 to the outside.

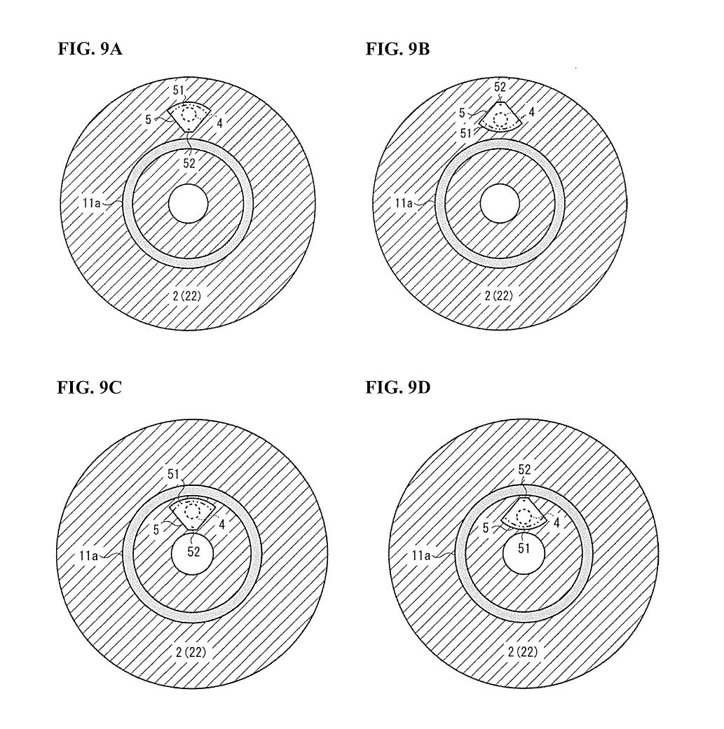

Next, examples of arrangement of the lid member 5 will be described. FIG. 9 shows examples of arrangement of the lid member, wherein FIG. 9A shows a first arrangement example, FIG. 9B shows a second arrangement example, FIG. 9C shows a third arrangement example, and FIG. 9D shows a fourth arrangement example. In each figure, the inflator 3 is omitted.

In the first to fourth arrangement examples shown in FIGS. 9 A to 9D, the relationship with the rim portion 11a of the steering wheel 11 and the position where the lid member 5 is connected are changed. As shown in these arrangement examples, the arrangement of the lid member 5 can be changed according to conditions such as the size of the steering wheel 11, the cleavage shape of the airbag cover 11b, and the shape of the airbag 2. In particular, in the case where the seam 51 of the lid member 5 is disposed on the radially inner side (for example, the first and third arrangement examples), compared to the case where the seam 51 of the lid member 5 is disposed on the radially outer side (for example, the second and fourth arrangement examples), the angle between the tight tether 6 and the lid member 5 can be brought close to 90 degrees, and when an occupant contacts the airbag 2, the tether 6 can be effectively slacked.

Specifically, in the first arrangement example of the lid member 5 shown in FIG. 9A, the lid member 5 is disposed on the outer side of the rim portion 11a, and the seam 51 is disposed on the radially outer side. In the second arrangement example of the lid member 5 shown in FIG. 9B, the lid member 5 is disposed on the outer side of the rim portion 11a, and the seam 51 is disposed on the radially inner side. In the third arrangement example of the lid member 5 shown in FIG. 9C, the lid member 5 is disposed on the inner side of the rim portion 11a, and the seam 51 is disposed on the radially outer side. In the fourth arrangement example of the lid member 5 shown in FIG. 9D, the lid member 5 is disposed on the inner side of the rim portion 11a, and the seam 51 is disposed on the radially inner side.

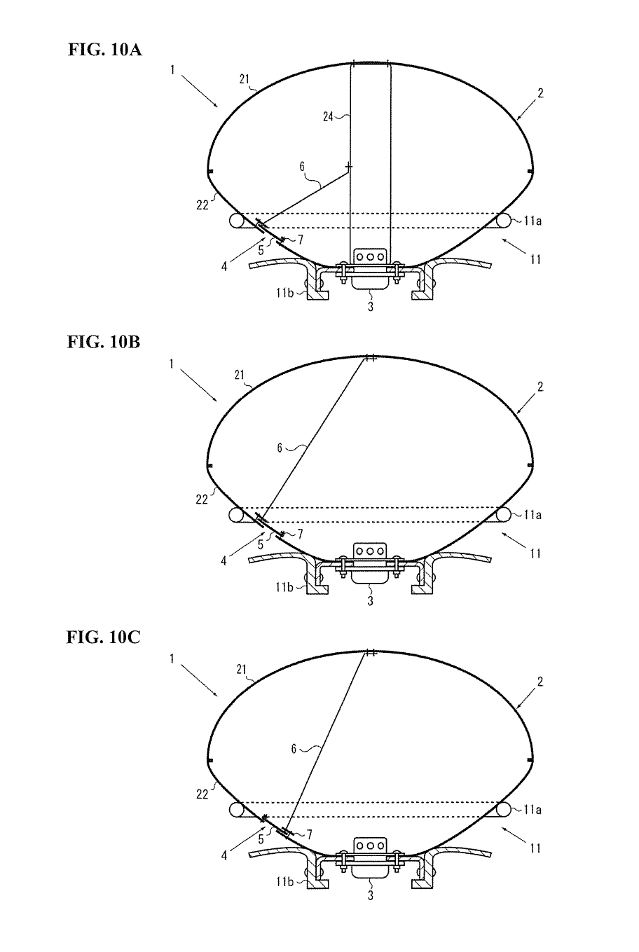

Finally, airbag devices according to other embodiments of the present invention will be described. FIG. 10 shows sectional views of airbag devices according to other embodiments of the present invention, wherein FIG. 10A shows a fourth embodiment, FIG. 10B shows a fifth embodiment, and FIG. 10C shows a sixth embodiment. The same reference numerals will be used to designate the same components as those in the third embodiment shown in FIG. 7, and the redundant description thereof will be omitted.

The fourth embodiment shown in FIG. 10A differs from the airbag device 1 according to the third embodiment shown in FIG. 7 in that the vent hole 4, the lid member 5, and the cover member 7 are disposed on the inner side of the rim portion 11a of the steering wheel 11. The end on the inflator 3 side of the lid member 5 is sewn to the airbag 2 (rear panel 22), and a tether 6 is connected to the end on the rim portion 11a side of the lid member 5. That is, the airbag device 1 according to the fourth embodiment is the application of the fourth arrangement example of the lid member 5 shown in FIG. 9D to the airbag device 1 according to the third embodiment.

The fifth embodiment shown in FIG. 10B differs from the airbag device 1 according to the fourth embodiment shown in FIG. 10A in that the end of the tether 6 is connected to the top of the airbag 2 (front panel 21). In an airbag 2 with no shape restricting member 24, the tether 6 may be sewn to a panel forming the airbag 2. The location to which the tether 6 is connected is not limited to the top of the airbag 2 (front panel 21), and the tether 6 can be connected to any location on the inner surface of the airbag 2.

The sixth embodiment shown in FIG. 10C differs from the airbag device 1 according to the fifth embodiment shown in FIG. 10B in that the end on the rim portion 11a side of the lid member 5 is sewn to the airbag 2 (rear panel 22), and a tether 6 is connected to the end on the inflator 3 side of the lid member 5. That is, the airbag device 1 according to the sixth embodiment is the application of the third arrangement example of the lid member 5 shown in FIG. 9C to the airbag device 1 according to the fifth embodiment.

As described above, the first to fourth arrangement examples of the lid member 5 shown in FIGS. 9A to 9D can be applied to the above-described airbag devices 1 and airbags 2 according to the first to third embodiments. The method for connecting the tether 6 can be changed according to the presence or absence of the shape restricting member 24. The modification of the tether 6 shown in FIG. 2C can be applied to each embodiment.

The present invention is not limited to the above-described embodiments, and can be applied to airbags other than driver-side airbags (for example, passenger-side airbags, side airbags, curtain airbags, knee airbags, and airbags for protecting a pedestrian). It goes without saying that various changes may be made without departing from the spirit of the present invention.

What is claimed is:

1. An airbag comprising:
a vent hole for releasing gas supplied in the airbag; and
a lid member for making the vent hole openable and closable;
wherein a seam formed by sewing the lid member to the airbag is disposed in a sewing region defined by a straight line shape spaced a predetermined distance from the vent hole, and a curved shape formed by bringing both ends of the straight line shape close to a center line of the vent hole parallel to the straight line shape, and
wherein a curvature of the seam can be regulated in view of lap width between the lid member and an outer edge of the vent hole.

2. The airbag according to claim 1, including a tether for applying tension to the lid member, and wherein the lid member is disposed on an outer surface of the airbag, the airbag has a tether opening through which the tether is inserted, and the tether opening is formed in a portion covered by the lid member.

3. The airbag according to claim 2, wherein the tether has a connecting portion sewn to the lid member, the connecting portion is wider than a tether main body portion inserted through the tether opening, the connecting portion has cuts formed along the tether main body portion, and protruding portions formed by the cuts cover the tether opening.

4. The airbag according to claim 1, wherein a cover member having an opening is disposed over the lid member such that the lid member can be ejected through the vent hole or the opening.

5. The airbag according to claim 4, wherein the lid member is disposed on an outer surface of the airbag, and the cover member is disposed on an outer side of the lid member; or the lid member is disposed on an inner surface of the airbag, and the cover member is disposed on an inner side of the lid member.

6. The airbag according to claim 4, wherein the opening has an opening area larger than the vent hole.

7. The airbag according to claim 1 in combination with an inflator that supplies gas to the airbag.

8. A method for sewing a lid member of an airbag, the airbag including a vent hole for releasing gas supplied in the airbag, the lid member for making the vent hole openable and closable, and a tether for applying tension to the lid member, the method comprising the steps of:
disposing a seam formed by sewing the lid member to the airbag in a sewing region defined by a straight line shape spaced a predetermined distance from the vent hole, and a curved shape formed by bringing both ends of the straight line shape close to a center line of the vent hole parallel to the straight line shape, and
regulating a curvature of the seam in view of lap width between the lid member and an outer edge of the vent hole so that an opening and closing of the vent hole can be regulated.

9. The method according to claim 8, further comprising the steps of disposing a cover member having an opening over the lid member, and putting the lid member between the airbag and the cover member so that the opening and closing of the vent hole can be regulated by changing size of the opening.

10. The method according to claim 9 wherein the tether is not connected to the airbag.
